(19) United States
(12) Patent Application Publication
(10) Pub. No.: US 2022/0001762 A1
(43) Pub. Date: Jan. 6, 2022

(54) PORTABLE ELECTRIC GENERATOR FOR CHARGING ELECTRIC VEHICLES

(71) Applicant: Blink Charging Co., Miami Beach, FL (US)

(72) Inventors: Michael D. Farkas, Miami Beach, FL (US); Joshua Winkler, Miami Beach, FL (US)

(21) Appl. No.: 16/920,523

(22) Filed: Jul. 3, 2020

(51) Int. Cl. B60L 53/50; H02J 7/00; B60L 53/16; B60L 53/18; B60L 53/30; B60L 53/62

(52) U.S. Cl. CPC B60L 53/50; H02J 7/0045; B60L 53/62; B60L 53/18; B60L 53/305; B60L 53/16

(57) ABSTRACT

A portable charging system for an electric vehicle is provided. The system includes a frame assembly, a fuel-powered electric generator coupled to the frame assembly, the electric generator including an internal combustion engine that produces power, a control module conductively connected to the electric generator, including an electrical circuit, and a computing device including a processor configured for engaging in asynchronous communication with an electric vehicle conductively coupled to the control module, and metering output power. The system further including a cable conductively coupled to the control module, and a plug conductively coupled to an end of the cable, the plug configured for conductively coupling to a port of an electric vehicle, so as to charge the electric vehicle with the output power.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to the field of electric vehicles and, more specifically, to systems and processes for improving charging of electric vehicles.

### BACKGROUND

In 2015, 300,000 electric vehicles (EVs) were sold in the U.S. alone. By 2018, over 1 million EVs were on the road. The number of EVs will continue to grow exponentially, as more models will be introduced at lower price points with longer driving ranges and faster charging speeds. Industry associations estimate that 18.7 million EVs will be on the road by 2030, requiring 9.6 million charge ports across the United States.

Although EVs have more than their share of advantages, it is worth noting that they are not without their drawbacks. EVs contain electric battery packs that provide power to run all of the vehicle's onboard electronics, including its electronic motor. The electric battery packs are typically recharged via stationary charging stations located at residential homes, as well as parking lots, dealerships, and other public places. Finding a charging station while on the road, however, can be a challenge, especially if one is driving through rural areas on a long-distance trip. EV owners often worry whether their EV has enough charge to arrive at their destination, lest they be stranded in the middle of nowhere, resulting a phenomena called range anxiety. Despite modern battery technology, the problem of range anxiety remains unresolved.

Therefore, a need exists for improvements over the prior art, and more particularly for more efficient and versatile methods and systems for charging the batteries of electric vehicles.

### SUMMARY

A method and system for portable charging of electric vehicles is provided. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, a portable charging system for an electric vehicle is provided. The system includes a frame assembly, a fuel-powered electric generator coupled to the frame assembly, the electric generator including an internal combustion engine that produces power, a control module conductively connected to the electric generator, the control module comprising: an electrical circuit configured to produce a predetermined output power, and a computing device including a processor configured for: 1) engaging in asynchronous communication with an electric vehicle conductively coupled to the control module, and 2) metering output power. The system further including a cable conductively coupled to the control module, so as to convey the output power, and a plug conductively coupled to an end of the cable, the plug configured for conductively coupling to a port of an electric vehicle, so as to charge the electric vehicle with the output power.

### BRIEF DESCRIPTION OF THE DRAWINGS

The accompanying drawings, which are incorporated in and constitute a part of this disclosure, illustrate various example embodiments. In the drawings:

FIG. 1 is a perspective left side view of a portable charging system for charging electric vehicles, according to an example embodiment;

FIG. 2 is a front perspective view of a portable charging system for charging electric vehicles, according to an example embodiment;

FIG. 3 is a perspective right side view of a portable charging system for charging electric vehicles, according to an example embodiment;

FIG. 4 is a perspective left side view of a frame assembly for housing a portable charging system for charging electric vehicles, according to an example embodiment;

FIG. 5 is a front view of a control module for a portable charging system for charging electric vehicles, according to an example embodiment;

FIG. 6 is a block diagram illustrating the main components of a control module for a portable charging system for charging electric vehicles, according to an example embodiment;

FIG. 7 is a flowchart describing the steps of the process performed during use of the portable charging system for charging electric vehicles, according to an example embodiment;

FIG. 8 is a block diagram of a system including an example computing device and other computing devices, according to an example embodiment.

### DETAILED DESCRIPTION

The following detailed description refers to the accompanying drawings. Wherever possible, the same reference numbers are used in the drawings and the following description to refer to the same or similar elements. While embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the claimed subject matter. Instead, the proper scope of the claimed subject matter is defined by the appended claims.

The claimed embodiments improve upon the prior art by providing a portable charging system for electric vehicles. Specifically, the claimed embodiments provide electric charging for EVs using a fuel-powered electric generator. Thus, even in the midst of a blackout or in the worst weather conditions that cause power outages, the claimed fuel-powered portable charging system can provide electric charging for EVs without having to rely upon an external power source or the public utility electrical system. This feature of the claimed embodiments reduces or eliminates the possibility that an EV is left stranded without the ability to recharge in a location that lacks an electrical power source.

The claimed embodiments further improve upon the prior art by providing electric charging for EVs using a fuel-powered electric generator that is portable. Thus, even in the most remote places, the claimed fuel-powered portable charging system can provide electric charging for EVs without having to rely upon an external power source or the public utility electrical system. Therefore, instead of having to tow an EV with a dead battery to a charging station, which is currently the norm, an emergency roadside service provider may conveniently transport the claimed system to charge up the EV on site, irrespective of the EV's location. This feature of the claimed embodiments reduces or eliminates the possibility that an EV is left stranded without the ability to recharge in a remote location.

The claimed embodiments further improve upon the prior art by providing a portable charging system for EVs that integrates an ISO 15118 and SAE J1772 standards as further defined below. The ISO 15118 standard is a vehicle to grid communication interface standard that enables the EV to automatically identify and authorize itself to a charging station on behalf of the driver to receive energy for recharging its battery. The only action required by the driver is to plug the charging cable into the EV and/or charging station. The ISO 15118 standard makes the process of charging an EV faster, more efficient, and secure. The SAE J1772 standard defines the general physical, electrical, communication protocol, and performance requirements for an EV charging system and coupler. The SAE J1772 standard makes the process of charging an EV safer, quicker, and more standardized.

As discussed above, along with the growth of EVs in the market, the need for more power has grown, which means more power generation, more infrastructure, and the technology to maximize and manage utility grid utilization. The grid can be roughly characterized as a combination of two infrastructures, the electrical grid carrying the energy, and the information infrastructure used to supervise and control the electrical grid operation. High spikes in electricity demand can cause stress on the grid, risking potential distribution system overloads and affecting stability, efficiency, and grid operating costs. In order to balance loads, innovative technologies like smart and bidirectional (vehicle-to-grid) charging, which utilize EVs as a distributed energy resource, must be implemented.

The key to managing the power demands created by the influx of EVs is through smart and bidirectional charging. Smart charging allows for maximum grid utilization by shifting EV charging loads while considering the vehicle owner's needs along with distributed energy resources and the integration of renewable energy (e.g. solar generation).

Providing energy management and smart charging reduces significant additional costs, such as demand charges, and enables power sharing for fleets. With bidirectional charging, EVs will be able to discharge electricity back to the grid where advanced energy management capabilities can facilitate load balancing, thereby making the EV a distributed energy resource. Most importantly, smart, and bidirectional charging enables resilience of the grid, allowing charging to be distributed throughout off-peak periods with flexible loads. This flexibility reduces costly grid infrastructure investment and upgrades for infrequent spikes in electricity demand The claimed embodiments further improve upon the prior art by providing a portable charging system for EVs that integrates energy management and smart charging.

Additionally, the data transported over the communication infrastructure of the claimed embodiments may be utilized to address potential threats as well as to determine suitable countermeasures, provide software updates for the EV's Engine Control Unit (ECU) or infotainment systems, and offer remote diagnosis, maintenance, and multimedia services during charging by roadside personnel.

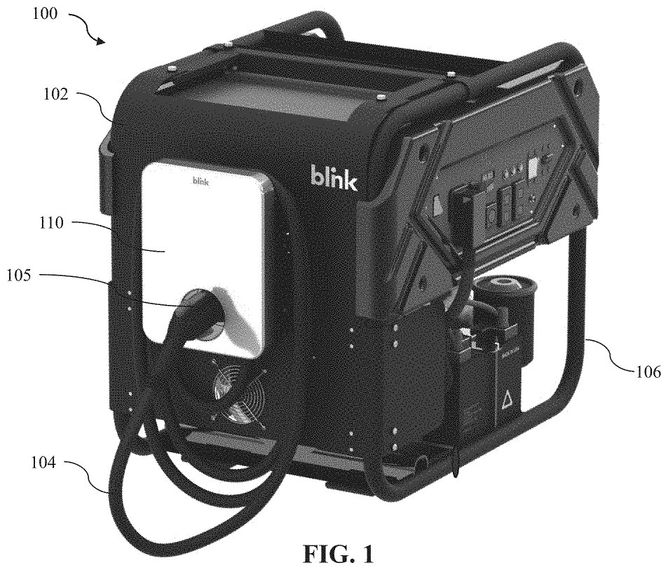

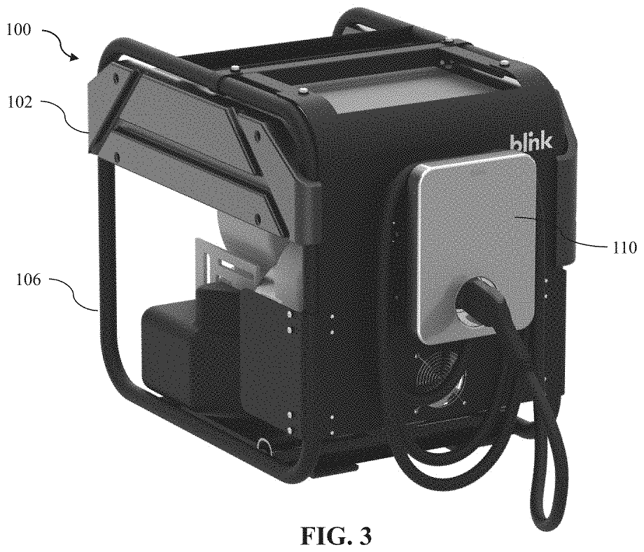

Referring now to the Figures, FIGS. 1-3 illustrate a portable charging system 100 for charging electric vehicles, or electric vehicle supply equipment (EVSE), according to an example embodiment and will be discussed together for ease of reference.

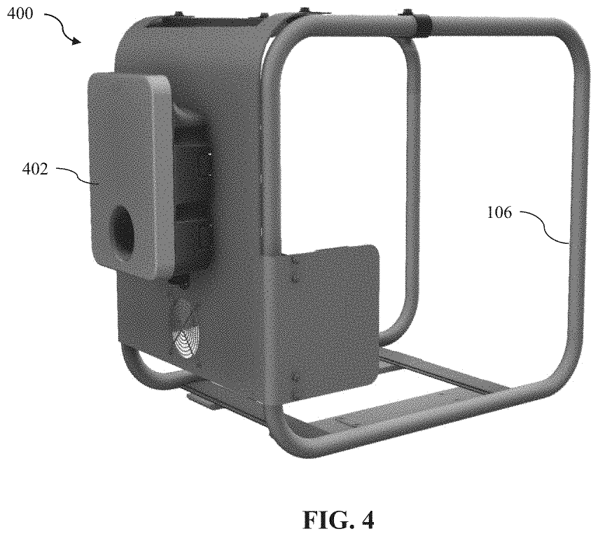

The portable charging system 100 includes a frame assembly 400 defining a rigid metal frame 106 and a housing 402 that is configured to hold or support a plurality of electrical and mechanical components of the system 100 as further discussed below. In one embodiment, as best shown in FIG. 4, the frame 106 includes a forward frame and a rearward frame. The forward frame includes a bottom frame, a top frame, and two side frames. The rearward frame includes a bottom frame, a top frame, and two side frames. The frame 106 further includes a plurality of spanning cross members interconnected between the forward frame and rearward frame. The forward frame, rearward frame, and plurality of spanning cross members may be integrally formed to each other or may be comprised of different pieces which may be secured to each other by any suitable means, such as mechanical fastening means or welding. In one embodiment, the frame is made of a suitably strong metal, such as steel. However, it should be appreciated that the frame may be made of any suitable material or combination of materials and that the shape, configuration, and size of the frame assembly may vary in accordance with the present invention. In one embodiment, the system 100 weights less than 400 pounds, adding to its portability.

The system further includes a fuel-powered electric generator 102 for converting mechanical energy into electrical energy as the output. The electric generator includes an internal combustion engine for providing the input mechanical energy to the generator. In one embodiment, the engine operates on gasoline, delivers up to 15.0 kW peak watts, delivers up to 12.0 kW continuous watts, and is configured to deliver 9.6 kW (40 A at 240 VAC) continuous watts (but could be configured to deliver more or less power), to provide the EV with 0.5 to 1 mile of range per minute, based on the size of the EV's on-board charger. It should be appreciated that the engine may operate on a variety of other suitable fuels such as diesel, propane (in liquefied or gaseous form), or natural gas.

The electric generator 102 further includes a tank for the storage of fuel. In one embodiment, the tank holds approximately 10.9 gallons (41.2 L) of fuel and provides up to 9 hours of run time at a 50% load. The electric generator 102 also includes a fuel valve controls the flow of fuel to the engine, a supply line directs fuel from the tank to the engine and a return line directs fuel from the engine to the tank. The fuel tank has a ventilation pipe to prevent the build-up of pressure or vacuum during refilling and drainage of the tank. A fuel injector atomizes the fuel and sprays the required amount of fuel into a combustion chamber of the engine.

The electric generator 102 further includes an alternator for producing the electrical output from the mechanical input supplied by the engine. The alternator contains an assembly of stationary and moving parts encased in a housing. The components work together to cause relative movement between the magnetic and electric fields, which in turn generates electricity. Additionally, a cooling and exhaust system is included to avoid overheating, regulate the temperature when in the generator is in use, and dispel harmful gases emitted during the operation of the generator.

The electric generator 102 further includes a voltage regulator to regulate the voltage produced and convert it from A/C to D/C current. Moreover, because the start function of the generator is battery-operated, the generator includes a battery charger that charges the battery while the generator is in operation. A control panel allows a user to monitor the various systems of the generator and adjust them as needed. These controls include the amount of voltage produced by the generator, the electrical current, and the frequency of that current. Monitoring of the system is provided by various gauges and displays, and the generator settings are adjusted through a series of buttons and/or switches.

The portable charging system 100 further includes an SAE J1772 charge connector 105 located at the end of a charging cable 104. SAE J1772 is a standard described more fully below. A cable 104 is coupled to the charge connector 105 at a first end and coupled to a control module 110 at a second end to electrically couple the charge connector to one or more electrical components within the control module, as further discussed below.

In operation, for charging an EV, the charge connector 105 is fitted to a charge port (also referred to as an inlet or socket) located on the EV. The charge connector includes a release button that is configured to be pressed for removal from the charge port located on the EV, and a release button circuit for detecting depression of the release button. The release button includes a locking mechanism for fastening to the EV when the charge connector and the charge port located on the EV are fitted to each other. Additionally, the release button is configured such that the locking mechanism is released by pressing the release button to disconnect the charge connector from the charge port located on the EV.

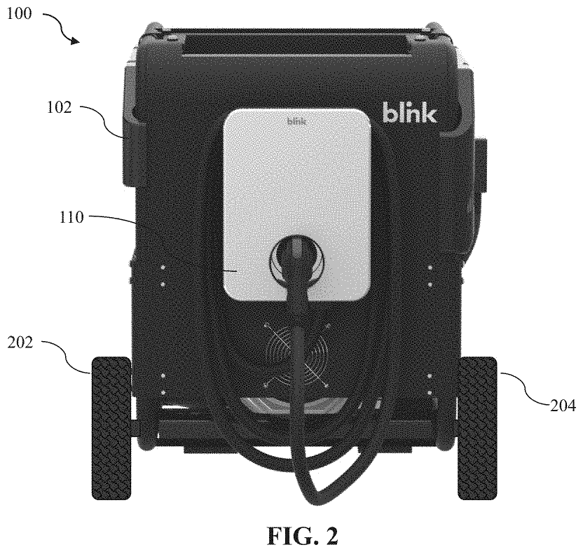

In one embodiment, as best illustrated in FIG. 2, the system includes wheels 202, 204 attached to a lower end of the frame 106 such that the system 100 may move along a surface or ground and be easily transported from one location to another. In one embodiment, a total of two wheels are attached by way of an axle (not shown) to each corner of the lower end of the frame 106, wherein the axle and wheels are adjustable to move forward and backward. It should be appreciated that the wheels may be of any size so long as the axle connections are suitable, and such variations are within the spirit and scope of the claimed embodiments.

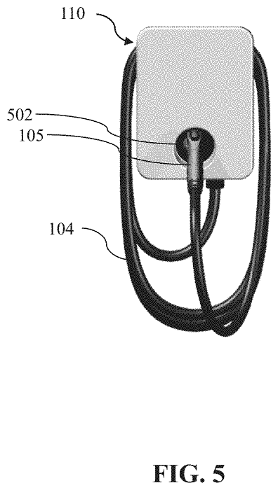

FIG. 4 is a perspective view showing a housing 402 for storing the control module 110, and FIG. 5 is a front view of the control module 110, according to an example embodiment. In one embodiment, the housing of the control module 110 comprises a set of vertical sidewalls, a set of horizontal end walls, a top wall, and a bottom wall that enclose and protect the electronic equipment located inside the control module. The top wall of the control module further includes a receptacle or holster 502 that is configured for receiving the charge connector 105 when the system 100 is not in use.

FIG. 5 is a front view of a control module 100 for a portable charging system 100 for charging electric vehicles, according to an example embodiment. The control module 110 is a separate component of the system 100 and includes an electrical system and a computing system that each performs certain functions described more fully below. The control module 110 may be communicatively coupled with a communications network 106, which may be a packet switched network, such as the Internet, or any local area network, wide area network, enterprise private network, cellular network, phone network, mobile communications network, or any combination of the above.

The control module 110 may include a software engine that delivers applications, data, program code and other information to networked devices. The software engine of device 110 may perform other processes such as transferring multimedia data in a stream of packets that are interpreted and rendered by a software application as the packets arrive. The control module 110 may include a database or repository, which may be a relational database comprising a Structured Query Language (SQL) database stored in a SQL server. The database may store and serve metering data, use data, hookup data and status data, as well as related information.

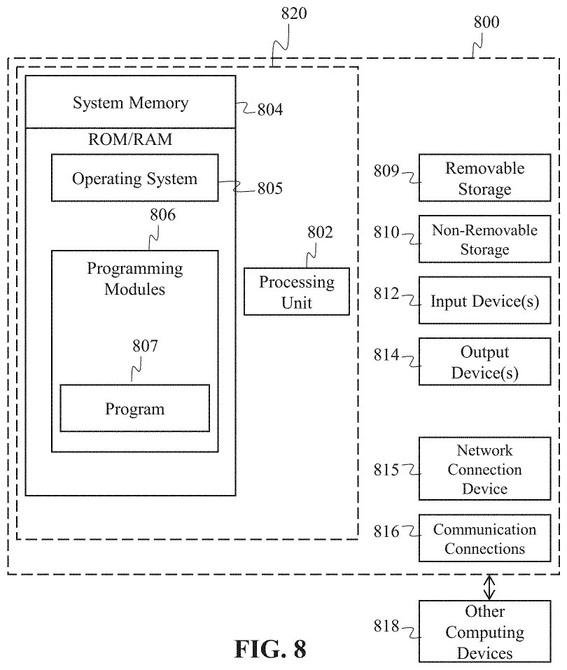

The control module 110 may include program logic comprising computer source code, scripting language code or interpreted language code that perform various functions of the disclosed embodiments. In one embodiment, the aforementioned program logic may comprise program module 807 in FIG. 8. It should be noted that although FIG. 1 shows only one control module 110 and one electric generator, the system of the disclosed embodiments supports any number of control modules and electric generators. Also note that although control module 110 is shown as a single and independent entity, in one embodiment, control module 110 and its functionality can be realized in a centralized fashion in one computer system or in a distributed fashion wherein different elements are spread across several interconnected computer systems.

The control module 110 may be compliant with the SAE J1772 standard and may include all of the features and functions associated with said standard. SAE J1772, also known as a J plug, is a standard for electrical connectors for electric vehicles maintained by SAE International, which is a U.S.-based, globally active professional association and standards developing organization for engineering professionals in various industries. SAE J1772 covers the general physical, electrical, communication protocol, and performance requirements for an electric vehicle charging system. SAE J1772 defines a common electric vehicle charging system architecture including operational requirements and the functional and dimensional requirements for the vehicle inlet and mating connectors.

The J1772 connector is approximately 43 millimeters in diameter with five (5) pins. Amongst the five pins, the two largest pins correspond to AC lines 1 and 2, the second largest pin is the ground pin, and the two smallest pins are used for proximity detection and control pilot. Each of these pins play an important role in ensuring safety both while in use and while idle. While the AC lines and ground pins are responsible for transmitting and regulating the electrical current, the proximity detection and control pilot pins regulate how and when to do so. The proximity detection pin provides a signal from module 110 to the vehicle control system, notifying it that the vehicle is connected to electric vehicle supply equipment (EVSE) and requesting that the vehicle initiate its locking sequence to prevent the vehicle from moving while connected to the EVSE. The proximity detection process is also responsible for notifying the EV once the latch on the connector has been pressed, allowing the user to disconnect the connector and the vehicle to initiate its unlocking sequence. While the EV is connected to the EVSE, the control pilot uses a 1 kHz square wave at +−12 volts to allow module 110 to detect the presence of the EV and communicate its maximum allowable charging current and communicating the begin and end stages of the charging process to the EV control system.

The J1772 standard includes several levels of shock protection, ensuring the safety of charging even in wet conditions. Physically, the connection pins are isolated on the interior of the connector when mated, ensuring no physical access to those pins. When not mated, J1772 connectors have no power voltages at the pins, and charging power does not flow until commanded by the vehicle. The ground pin is of the first-make, last-break variety. If the plug is in the charging port of the vehicle and charging, and it is removed, the shorter control pilot pin will break first causing the power relay in the EVSE to open, stopping current flow to the J1772 plug. This prevents any arcing on the power pins, prolonging their lifespan. The proximity detection pin is also connected to a switch that is triggered upon pressing the physical disconnect button when removing the connector from the vehicle. This causes the resistance to change on the proximity pin which commands the vehicle's onboard charger to stop drawing current immediately.

The J1772 standard includes a signaling protocol that is configured so that the control module 110 signals the presence of AC input power to the EV, the vehicle detects plug via proximity circuit (thus the vehicle can prevent driving away while connected) and can detect when latch is pressed in anticipation of plug removal, the control pilot functions above begin; control module 110 detects plug-in EV, control module 110 indicates to EV its readiness to supply energy; EV ventilation requirements are determined, control module 110 current capacity provided to EV, EV commands energy flow from control module 110, EV and control module 110 continuously monitor continuity of safety ground, charge continues as determined by EV and charge may be interrupted by disconnecting the plug from the EV.

The control module 110 may be compliant with the ISO 15118 standard and may include all of the features and functions associated with said standard. The user-convenient and secure “plug and charge” feature of ISO 15118 enables the electric vehicle to automatically identify and authorize itself to the control module 110 on behalf of the driver to receive energy for recharging its battery. The only action required by the driver is to plug the charging cable into the EV and/or control module 110. The plug and charge feature deploys several cryptographic mechanisms to secure this communication and guarantee the confidentiality, integrity, and authenticity of all exchanged data, using digital certificates and public-key infrastructures. The plug-and-charge nature of ISO 15118 allows charging to begin and end automatically, without the user having to manually engage the control module 110. It increases functionality by communicating information about the vehicle's charging needs, desired departure time, status of the electrical grid, as well as payment schedule information. Consequently, the control module 110 is configured to perform asynchronous communication with the EV either wirelessly or through the charging cable 104 in compliance with the SAE J1772 and ISO 15118 standards. The control module 110 is also configured to perform asynchronous communication with other nodes on a communications network in compliance with the SAE J1772 and ISO 15118 standards.

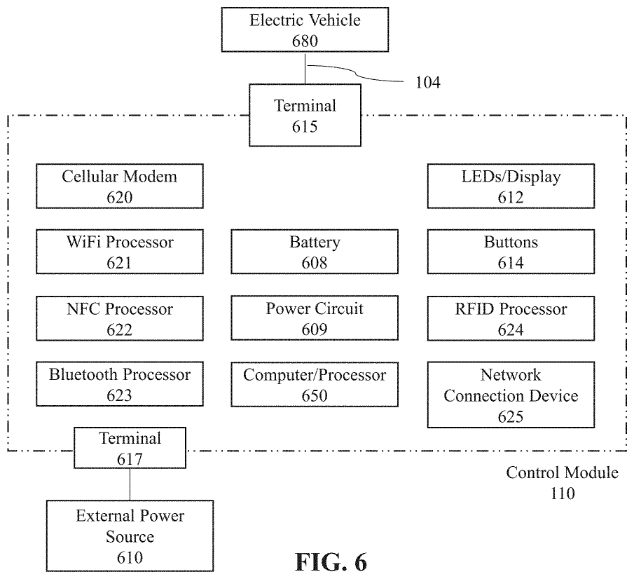

FIG. 6 is a block diagram illustrating the main components of a control module 110 for the system 100, according to an example embodiment. External power source 610 (such as the electric generator 102) is conductively coupled, and provides power, to an external terminal 617, which is conductively coupled to other components of the control module 110, such as rechargeable battery 608. The terminal 617 is the point at which a conductor from control module 110 comes to an end and provides a point of connection to external circuits. A terminal may simply be the end of a wire or it may be fitted with a connector or fastener. The terminal may be a male jack, male connector, a female jack, a female connector, a USB connector, a plug, a connector, or the like. The terminal may be any plug or connector that is used to transfer data and/or electrical current. The terminal may also be a magnetic terminal, which may be a magnetically attached power or data connector. The magnetic terminal is held in place magnetically so that if it is tugged, it will pull out of the connection without damaging the components. The terminal may also be referred to as a power port, plug, jack, or connector.

The external power source can be a DC or AC power source or power supply, such as a rechargeable solar powered battery, battery, line voltage, etc. The rechargeable battery 608 can be a single battery or a plurality of conductively coupled batteries, wherein each battery can comprise a variety of configurations or arrangements, such lead-acid, nickel cadmium (NiCad), nickel metal hydride (NiMH), lithium ion (Li-ion), and lithium ion polymer (Li-ion) polymer or any combination thereof. The rechargeable battery 608 may be removable in the same manner in which rechargeable batteries are removable from appliances, as is well known within the art.

In one embodiment, the control module 110 supports wireless charging, otherwise known as inductive charging. In this embodiment, the external power source 610 wirelessly provides power to the battery 608 using wireless charging. In this embodiment, the control module 110 would include a wireless charging system (well known in the art) that includes an induction coil that interacts with an induction coil associated with the external power source, so as to execute inductive charging.

The control module 1120 includes a processor 650 and a network connection device 625, as described more fully below. A network connection device 625 (also known as a network interface card, network adapter, LAN adapter and by similar terms) is a computer hardware component that connects a computer to a computer network. The network interface device implements the electronic circuitry required to communicate using a communications protocol such.

The control module 110 may further include a near-field communication (NFC) processor 622 that allows the control module 110 to easily share data with other NFC-equipped devices. NFC processor 622 includes all of the hardware and software necessary to implement the NFC standard communication protocol for communication between two electronic devices over a distance of 4 cm (1½ in) or less. The control module 110 may further include a Bluetooth processor 623 that allows the control module 110 to utilize the wireless technology standard for exchanging data between devices over short distances using short-wavelength UHF radio waves in the industrial, scientific and medical radio bands, from 2.402 GHz to 2.480 GHz. Bluetooth processor 623 includes all of the hardware and software necessary to implement the Bluetooth standard communication protocol for communication between two electronic devices. The control module 110 may further include a Wi-Fi processor 621 that allows the control module 110 to utilize the wireless networking technology, based on the IEEE 802.11 family of standards, for local area networking of devices and Internet access. Wi-Fi processor 621 includes all of the hardware and software necessary to implement the Wi-Fi standard communication protocol for communication between two electronic devices. The control module 110 may further include a cellular or wireless broadband modem, which is a type of modem that allows control module 110 to receive Internet access via a mobile wireless broadband connection. The control module 110 may further include a radio-frequency identification (RFID) processor or reader 624 whereby digital data encoded in RFID tags or smart labels are captured by a reader via radio waves.

Additionally, a second terminal 615 on the control module 110 is configured to receive an end of the charging cable 104, such that the EV 680 is charged when the charging connector 105 coupled to the end of the charging cable is fitted to a charge port or inlet located on the EV. In one embodiment, the control module may include lights, LEDs, or a display 612, as well as buttons 614 located on the front exterior of the control module. Variously touching the screen or buttons (e.g., with one's finger or a hard object such as a pen or stylus) sends a “user input” signal to computer 650 and may be used to interface with the control module 110 and/or computer 650. LED lights can be used for indicating the amount of power remaining in the battery and/or the amount of charging that is necessary for full recharging of the battery of the EV. The LEDs can be different colors and sizes and various combinations of colors can indicate varying levels of charge remaining in the battery. Buttons 614 can be a push button or any small knob or disk that when pressed activates an electric circuit and is connected to the bus and can be used to open or close the electrical circuit when the button or knob is depressed. The buttons can be used for powering on and off the system 100 or module 110 as well as for adjusting the settings and parameters of the system 100 or module 110, as well as other functions, as defined more fully below.

Processor 650 is used to control, through the communications bus, functions including the charging of the EV and to control the LEDs and/or graphical user interface display. Processor 650 could be any type of processor such as a microcontroller, a programmable logic controller or an ASIC (Application Specific Integrated Circuit). One of the many functions performed by the processor 650 may include metering, which measures the amount of electric energy produced by the generator 102 and consumed by the EV to which the system 100 is attached. Electric energy is typically measured by kilowatt hour (kWh) which is equal to the amount of energy used by a load of one kilowatt over a period of one hour, or 3,600,000 joules. In addition to measuring energy used, the metering processes of processor 650 can also record other parameters of the load and supply such as instantaneous and maximum rate of usage demands, voltages, power factor and reactive power used. Processor 650 may also include additional functionality including a real-time or near real-time reads, power outage notification, and power quality monitoring. The module 110 may include a voltage reference, samplers and quantisers followed by an analog to digital conversion section to yield the digitized equivalents of all the inputs. These inputs are then processed using a digital signal processor to calculate the various metering parameters measured by the metering processes.

Control module 110 may further include one or more power circuits 609 for performing a variety of electrical functions. One or more of said power circuits may include a ground monitoring circuit, or ground continuity monitor (also called a ground integrity monitor or ground continuity tester), which is an electrical safety device that continuously monitors the impedance to ground of an electrical circuit between an outgoing and returning current (between the control module 110 and the EV and/or between the control module 110 and the generator 102) and can provide indication (or protective trip) in the event impedance rises to an unsafe value. Said circuit measures the electrical continuity of a circuit's path to ground. One or more of said power circuits 609 may include a ground fault circuit interrupter (GFCI), ground fault interrupter (GFI) or appliance leakage current interrupter (ALCI), which is a device that quickly breaks an electrical circuit to prevent serious harm from an ongoing electric shock.

One or more of said power circuits 609 may include a charge circuit interrupting device (CCID) that provides ground-fault protection to electric vehicle charging stations. Ground fault protection is equipment protection from the effects of ground faults. A ground fault is an inadvertent contact between an energized conductor and ground or equipment frame. The return path of the fault current is through the grounding system and any personnel or equipment that becomes part of that system. The CCID interrupts the output power to the plug conductively coupled to the end of the cable in the event that a loss of isolation is detected. The CCID may include an adjustable time delay to avoid nuisance tripping if a measured signal is noisy or unstable One or more of said power circuits 609 may include a nuisance tripping avoidance circuit that avoid nuisance tripping. Nuisance tripping is not the tripping of a breaker when doing its designed function but rather when the residual current flowing in the circuit is less than its rated residual operating current. One or more of said power circuits 609 may include a cold load pickup, which provides randomized auto-restart following a power outage, i.e., providing controlled power reconnection following a power outage.

One or more of said power circuits 609 may include a circuit that converts the power produced by the electric generator 102 to a predetermined output power. For example, the power circuit may convert input DC power produced by the generator 102 and convert it to AC power that is fed to the EV via charging cable 104. Hence, the power circuit may convert between DC and AC, and vice versa. The power circuit may further convert from one input voltage to another, as well as from one input amperage to another. The power circuit may further convert from one input power (kW) to another. In one embodiment, the control module supports a power output of up to 19.2 kW. One or more of said power circuits 609 may include a circuit that acts as a power conditioner, (also known as a line conditioner or power line conditioner) that improves the quality of the power that is delivered to the EV 680 from the power source 610. The power conditioner delivers a voltage of the proper level and characteristics to enable proper charging of the EV 680. The power conditioner may be a voltage regulator and may improve power quality, such as power factor correction, noise suppression, transient impulse protection, etc.

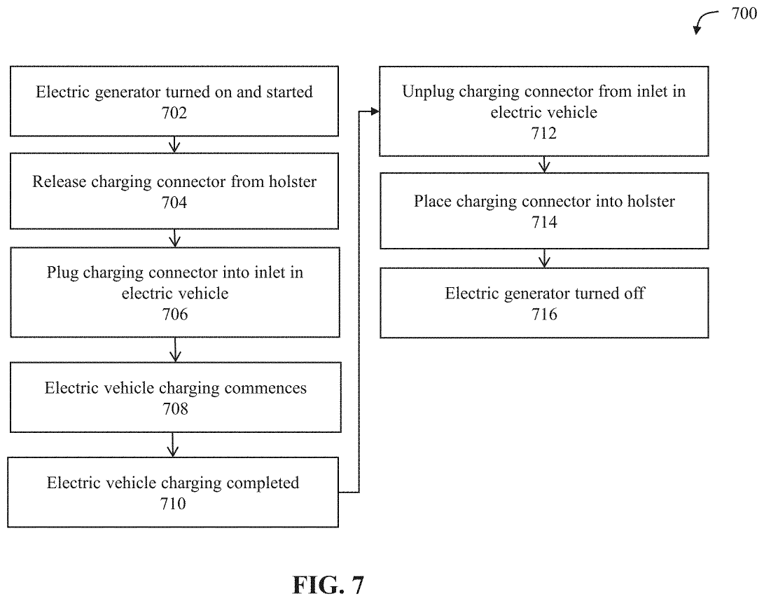

FIG. 7 is a flowchart describing the steps of the process 700 for initiating a charge session using a portable charging system 100, according to an example embodiment. The sequence of steps depicted is for illustrative purposes only and is not meant to limit the method in any way as it is understood that the steps may proceed in a different logical order, additional or intervening steps may be included, or described steps may be divided into multiple steps, without detracting from the invention. In step 702, the electric generator 102 and system 100 is turned on by rotating the fuel valve to an “ON” position, pulling the choke knob outward, and flipping the ignition switch to the “ON” position. In step 704, the plug or charge connector 105 is removed from the receptacle or holster 502 located on the control module 110. In step 706, the plug or charge connector 105 is fitted to the charge port located on the EV. In step 706, the control module 110 asynchronously communicates with the EV either wirelessly or through the charging cable 104 in compliance with the SAE J1772 and ISO 15118 standards. In step 708, charging of the EV commences. During charging, the control module 110 asynchronously communicates with the EV either wirelessly or through the charging cable 104 in compliance with the SAE J1772 and ISO 15118 standards. In one embodiment, before or during step 708, the control module 110 asynchronously communicates with other nodes (such as payment processors) on a communications network (such as the Internet) in compliance with the SAE J1772 and ISO 15118 standards.

In step 710, charging of the EV is completed, and said completion may be communicated by the EV to the control module 110 in compliance with the SAE J1772 standard. Thereafter, in step 712, the release button is pressed to disengage the locking mechanism and the charge connector is unplugged from the charge port located on the EV. Additional safety data may be communicated between the EV and the control module 110 in compliance with the above standards in step 712. In step 714, the cable 104 is coiled around the control module 110 and the plug or charge connector 105 is returned to the receptacle 502 located on the control module. In step 716, the electric generator 102 is turned off by flipping the ignition switch to the “OFF” position and turning the fuel valve to the “OFF” position.

FIG. 8 is a block diagram of a system including an example computing device 800 and other computing devices. Consistent with the embodiments described herein, the aforementioned actions performed by devices 102, 110 or 650 may be implemented in a computing device, such as the computing device 800 of FIG. 8. Any suitable combination of hardware, software, or firmware may be used to implement the computing device 800. The aforementioned system, device, and processors are examples and other systems, devices, and processors may comprise the aforementioned computing device. Furthermore, computing device 800 may comprise an operating environment for system 100 and process 700, as described above. Process 700 may operate in other environments and are not limited to computing device 800.

With reference to FIG. 8, a system consistent with an embodiment may include a plurality of computing devices, such as computing device 800. In a basic configuration, computing device 800 may include at least one processing unit 802 and a system memory 804. Depending on the configuration and type of computing device, system memory 804 may comprise, but is not limited to, volatile (e.g. random-access memory (RAM)), non-volatile (e.g. read-only memory (ROM)), flash memory, or any combination or memory. System memory 804 may include operating system 805, and one or more programming modules 806. Operating system 805, for example, may be suitable for controlling computing device 800's operation. In one embodiment, programming modules 806 may include, for example, a program module 807 for executing the actions of devices 102, 110 or 650. Furthermore, embodiments may be practiced in conjunction with a graphics library, other operating systems, or any other application program and is not limited to any particular application or system. This basic configuration is illustrated in FIG. 8 by those components within a dashed line 820.

Computing device 800 may have additional features or functionality. For example, computing device 800 may also include additional data storage devices (removable and/or non-removable) such as, for example, magnetic disks, optical disks, or tape. Such additional storage is illustrated in FIG. 8 by a removable storage 809 and a non-removable storage 810. Computer storage media may include volatile and nonvolatile, removable, and non-removable media implemented in any method or technology for storage of information, such as computer readable instructions, data structures, program modules, or other data. System memory 804, removable storage 809, and non-removable storage 810 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 800. Any such computer storage media may be part of device 800. Computing device 800 may also have input device(s) 812 such as a keyboard, a mouse, a pen, a sound input device, a camera, a touch input device, etc. Output device(s) 814 such as a display, speakers, a printer, etc. may also be included. Computing device 800 may also include a vibration device capable of initiating a vibration in the device on command, such as a mechanical vibrator or a vibrating alert motor. The aforementioned devices are only examples, and other devices may be added or substituted.

Computing device 800 may also contain a network connection device 815 that may allow device 800 to communicate with other computing devices 818, such as over a network in a distributed computing environment, for example, an intranet or the Internet. Device 815 may be a wired or wireless network interface controller, a network interface card, a network interface device, a network adapter, or a LAN adapter. Device 815 allows for a communication connection 816 for communicating with other computing devices 818. Communication connection 816 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 804, including operating system 805. While executing on processing unit 802, programming modules 806 (e.g. program module 807) may perform processes including, for example, one or more of the stages of the process 700 as described above. The aforementioned processes are examples, and processing unit 802 may perform other processes. Other programming modules that may be used in accordance with embodiments herein may include electronic mail and contacts applications, word processing applications, spreadsheet applications, database applications, slide presentation applications, drawing or computer-aided application programs, etc.

Generally, consistent with embodiments herein, program modules may include routines, programs, components, data structures, and other types of structures that may perform particular tasks or that may implement particular abstract data types. Moreover, embodiments herein may be practiced with other computer system configurations, including hand-held devices, multiprocessor systems, microprocessor-based or programmable consumer electronics, minicomputers, mainframe computers, and the like. Embodiments herein may also be practiced in distributed computing environments where tasks are performed by remote processing devices that are linked through a communications network. In a distributed computing environment, program modules may be located in both local and remote memory storage devices.

Furthermore, embodiments herein may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments herein may also be practiced using other technologies capable of performing logical operations such as, for example, AND, OR, and NOT, including but not limited to mechanical, optical, fluidic, and quantum technologies. In addition, embodiments herein may be practiced within a general-purpose computer or in any other circuits or systems.

Embodiments herein, for example, are described above with reference to block diagrams and/or operational illustrations of methods, systems, and computer program products according to said embodiments. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments have been described, other embodiments may exist. Furthermore, although embodiments herein have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages, and/or inserting or deleting stages, without departing from the claimed subject matter.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A portable charging system for an electric vehicle, the system comprising:
a frame assembly;
a fuel-powered electric generator coupled to the frame assembly, the electric generator including an internal combustion engine that produces power;
a control module conductively connected to the electric generator, the control module comprising:
an electrical circuit configured as a power conditioner for improving a quality of the power produced by the electric generator to a predetermined output power;
a computing device including a processor configured for: 1) engaging in asynchronous communication with an electric vehicle conductively coupled to the control module, and 2) metering power usage;
a cable conductively coupled to the control module, so as to convey the output power; and
a plug conductively coupled to an end of the cable, the plug configured for conductively coupling to a port of an electric vehicle, so as to charge the electric vehicle with the output power.

2. The system of claim 1, wherein the control module further includes a ground monitoring circuit to provide continuous surveillance of impedance to ground between an outgoing and returning current.

3. The system of claim 2, wherein the control module further includes a charging circuit interrupting device (CCID) configured to interrupt the output power to the plug conductively coupled to the end of the cable in the event that a loss of isolation is detected.

4. The system of claim 3, wherein the CCID includes an adjustable time delay to avoid nuisance tripping if a measured signal is noisy or unstable.

5. The system of claim 1, wherein the control module is configured to provide controlled power reconnection following a power outage.

6. The system of claim 1, wherein the system weights less than 400 pounds.

7. The system of claim 1, wherein the system supports a power output of up to 19.2 kW.

8. The system of claim 1, wherein the plug conductively coupled to the end of the cable is a J1772 standard electric vehicle connector.

9. A portable charging system for an electric vehicle, the system comprising:
a frame assembly;
a fuel-powered electric generator coupled to the frame assembly, the electric generator including an internal combustion engine that produces power;
a pair of wheels coupled to the frame, so as to move the system on the wheels;
a control module conductively connected to the electric generator, the control module comprising:
an electrical circuit configured as a power conditioner for improving a quality of the power produced by the electric generator to a predetermined output power;
a computing device including a processor configured for: 1) engaging in asynchronous communication with an electric vehicle conductively coupled to the control module, and 2) metering power usage;
a cable conductively coupled to the control module, so as to convey the output power; and
a plug conductively coupled to an end of the cable, the plug configured for conductively coupling to a port of an electric vehicle, so as to charge the electric vehicle with the output power.

10. The system of claim 9, wherein the control module further includes a ground monitoring circuit to provide continuous surveillance of impedance to ground between an outgoing and returning current.

11. The system of claim 10, wherein the control module further includes a charging circuit interrupting device (CCID) configured to interrupt the output power to the plug conductively coupled to the end of the cable in the event that a loss of isolation is detected.

12. The system of claim 11, wherein the CCID includes an adjustable time delay to avoid nuisance tripping if a measured signal is noisy or unstable.

13. The system of claim 9, wherein the control module is configured to provide controlled power reconnection following a power outage.

14. The system of claim 9, wherein the system weights less than 400 pounds.

15. The system of claim 9, wherein the system supports a power output of up to 19.2 kW.

16. The system of claim 9, wherein the plug conductively coupled to the end of the cable is a J1772 standard electric vehicle connector.

17. A portable charging system for an electric vehicle, the system comprising:
a frame assembly;
a fuel-powered electric generator coupled to the frame assembly, the electric generator including an internal combustion engine that produces power;
a pair of wheels coupled to the frame, so as to move the system on the wheels;
a control module conductively connected to the electric generator, the control module comprising:
an electrical circuit configured for converting the power produced by the electric generator to a predetermined output power;
a computing device including a processor configured for: 1) engaging in asynchronous communication with an electric vehicle conductively coupled to the control module, and 2) metering power usage;
a cable conductively coupled to the control module, so as to convey the output power; and
a plug conductively coupled to an end of the cable, the plug configured for conductively coupling to a port of an electric vehicle, so as to charge the electric vehicle with the output power.

18. The system of claim 17, wherein the control module further includes a ground monitoring circuit to provide continuous surveillance of impedance to ground between an outgoing and returning current.

19. The system of claim 18, wherein the control module further includes a charging circuit interrupting device (CCID) configured to interrupt the output power to the plug conductively coupled to the end of the cable in the event that a loss of isolation is detected.
